(19) United States
(12) Patent Application Publication
(10) Pub. No.: US 2008/0056540 A1
(43) Pub. Date: Mar. 6, 2008

(54) SYSTEM AND METHOD FOR BIOMETRIC SCAN INTEGRATED ELECTROPHYSIOLOGY AND HEMODYNAMIC PHYSIOLOGICAL DIAGNOSTIC MONITORING DURING CLINICAL INVASIVE PROCEDURES

(75) Inventors: Sachin Vadodaria, Fox Point, WI (US); Claudio Patricio Mejia, Wauwatosa, WI (US); Richard William Schefelker, Menomonee Falls, WI (US)

Correspondence Address: MCANDREWS HELD & MALLOY, LTD, 500 WEST MADISON STREET, SUITE 3400, CHICAGO, IL, 60661, US

(73) Assignee: GENERAL ELECTRIC COMPANY, Schenectady, NY (US)

(21) Appl. No.: 11/567,565

(22) Filed: Dec. 6, 2006

Related U.S. Application Data
(60) Provisional application No. 60/824,397, filed on Sep. 1, 2006.

(51) Int. Cl. G06K 9/00

(52) U.S. Cl. 382/115

(57) ABSTRACT

Certain embodiments provide systems and methods for biometric identification in an integrated electrophysiology and hemodynamic diagnostic monitoring environment. Certain embodiments provide a clinical diagnostic system accessible via biometric identification. The system includes a biometric scanner integrated with the clinical diagnostic system and a processing device in communication with the biometric scanner. The biometric scanner receives biometric data from a user. The processing device receives the biometric data from the biometric scanner and verifies the biometric data against a stored biometric identification. The processing device allows user access to the clinical diagnostic system based on the verification.

### RELATED APPLICATIONS

This application claims priority to a provisional application entitled “System and Method for Biometric Scan Integrated Electrophysiology and Hemodynamic Physiological Diagnostic Monitoring During Clinical Invasive Procedure,” filed on Sep. 1, 2006, as Ser. No. 60/824,397, which is herein incorporated by reference in its entirety.

### BACKGROUND OF THE INVENTION

The present invention generally relates to an integrated electrophysiology (EP) and hemodynamic (Hemo) environment. More specifically, certain embodiments of the present invention related to systems and methods for biometric scan integrated EP and Hemo physiological diagnostic monitoring during clinical invasive procedures.

During clinical invasive procedures, such as interventional cardiology or radiology procedures, there is a need to continuously monitor physiologic parameters of a patient. Monitoring a patient is done using physiological monitoring and recording systems, such as the GE Mac-Lab for hemodynamic procedures and the GE CardioLab for Electrophysiology procedures. The systems are computer-based and require passwords to authenticate or validate authorized users to use the system. Based on legal and/or regulatory privacy requirements, a password requirement is often expected and necessary for use of a clinical system. Currently, passwords are entered using a keyboard and are comprised of alphanumeric digits that a user has to input periodically. In most systems, the passwords entered are required at different times during the use of the system, including when changing system settings and user preferences. Repeated entry of passwords impedes clinical workflow and increases the time taken to provide the needed care for the patient. This increase in case time adds risk of complications for the patient.

Thus, there is a need for systems and methods for providing improved authentication and access in an integrated EP/Hemo environment. There is a need for systems and methods for improved authentication and access in an integrated EP/Hemo environment for physiological diagnostic monitoring during a clinical invasive procedure. There is a need for systems and methods for biometric scan integrated EP and Hemo physiological diagnostic monitoring during clinical invasive procedures.

### BRIEF SUMMARY OF THE INVENTION

Certain embodiments provide systems and methods for biometric identification in an integrated electrophysiology and hemodynamic diagnostic monitoring environment.

Certain embodiments provide a clinical diagnostic system accessible via biometric identification. The system includes a biometric scanner integrated with the clinical diagnostic system and a processing device in communication with the biometric scanner. The biometric scanner receives biometric data from a user. The processing device receives the biometric data from the biometric scanner and verifies the biometric data against a stored biometric identification. The processing device allows user access to the clinical diagnostic system based on the verification.

Certain embodiments provide a method for biometric authentication of a user at a physiological monitoring and recording system for hemodynamic and electrophysiology procedures. The method includes prompting a user for biometric identification and obtaining biometric data from the user via a biometric scanner integrated with the physiological monitoring and recording system for hemodynamic and electrophysiology procedures. The method further includes comparing the obtained biometric data to stored biometric data and allowing access to a function at the physiological monitoring and recording system for hemodynamic and electrophysiology procedures when the obtained biometric data is identified as matching the stored biometric data.

Certain embodiments provide a computer-readable medium including a set of instructions for execution on a computer. The set of instructions includes a biometric scanning routine receiving biometric identification data for a user. The biometric scanning routine is integrated with a clinical diagnostic system. The set of instructions also includes a verification routine verifying access to functionality of the clinical diagnostic system based on a comparison of the biometric identification data to stored biometric identification data.

### BRIEF DESCRIPTION OF SEVERAL VIEWS OF THE DRAWINGS

FIG. 1 illustrates a high-level system diagram of an integrated EP/Hemo and ultrasound system in accordance with an embodiment of the present invention.

FIG. 2 illustrates a more detailed diagram of an integrated EP/Hemo and ultrasound system in accordance with an embodiment of the present invention.

FIG. 3 illustrates a flow diagram for a method for exchanging physiological signal data between an EP/Hemo recording/monitoring system and an ultrasound system in accordance with an embodiment of the present invention.

FIG. 4 illustrates an integrated EP/Hemo system with biometric scanning capability in accordance with an embodiment of the present invention.

FIG. 5 illustrates a flow diagram for a method for biometric identification in an integrated EP/Hemo system in accordance with an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

Certain embodiments of the present invention provide an electrophysiology and hemodynamic (EP/Hemo) recording or monitoring system with an ability to exchange physiological signal data with an ultrasound system. Certain embodiments provide methods for exchanging physiologic signal data between an EP/Hemo recording system and an ultrasound system or other similar system. The signal data may be electrocardiogram (ECG) and/or intracardiac waveform data, for example. In certain embodiments, EP/Hemo recording systems are tightly integrated with ultrasound systems. Such tight integration allows information, such as physiological waveform information, to be exchanged. The waveform information is thus available both in the EP/Hemo System and in the ultrasound system (e.g., the GE Vivid-I system) simultaneously or substantially simultaneously (due to some inherent delay). Both systems are displaying the same signal, which allows signal information to be correlated with image information (e.g., correlation of ECG/intracardiac waveform data with an ultrasound image).

Certain embodiments of the EP/Hemo data acquisition system provide an analog physiological signal to the ultrasound system. The connection from the EP/Hemo data acquisition system to the ultrasound system may be implemented using an ECG or other waveform input port, for example. In an embodiment, an ECG input port is used with a two-wire cable (one wire for an ECG electric signal and one wire for ground) having an input level of plus or minus 1 V, an input impedance of great that 10 megaohms, and a source-dependent bandwidth and dynamic range. Of course, details of the port and connecting cable may vary greatly depending upon system, data and operating conditions. This is but one illustrative example.

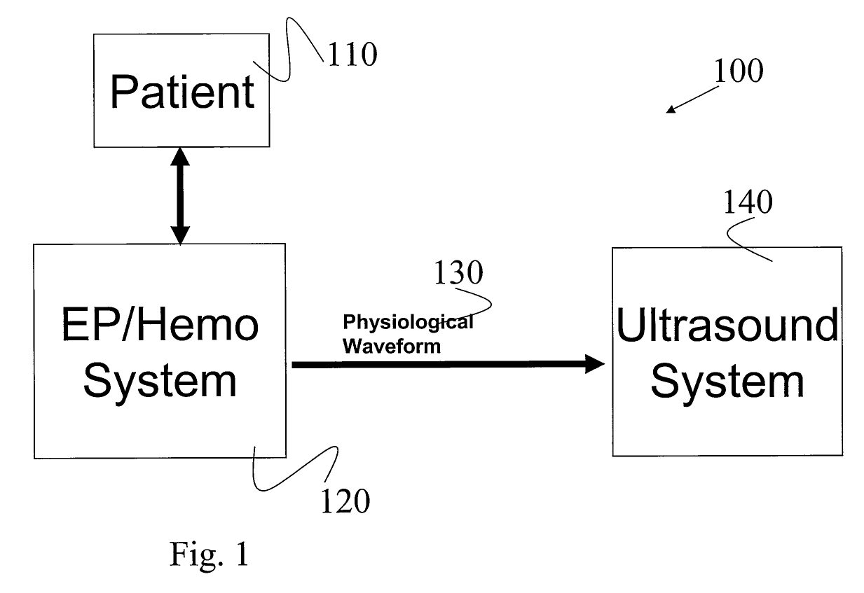

FIG. 1 illustrates a high-level system diagram of an integrated EP/Hemo and ultrasound system 100 in accordance with an embodiment of the present invention. The system 100 includes a patient providing data 110 to an EP/Hemo system 120. The EP/Hemo system 120 sends physiological waveform data 130 and/or other data to an ultrasound system 140 (e.g., a Vivid-I or other ultrasound system).

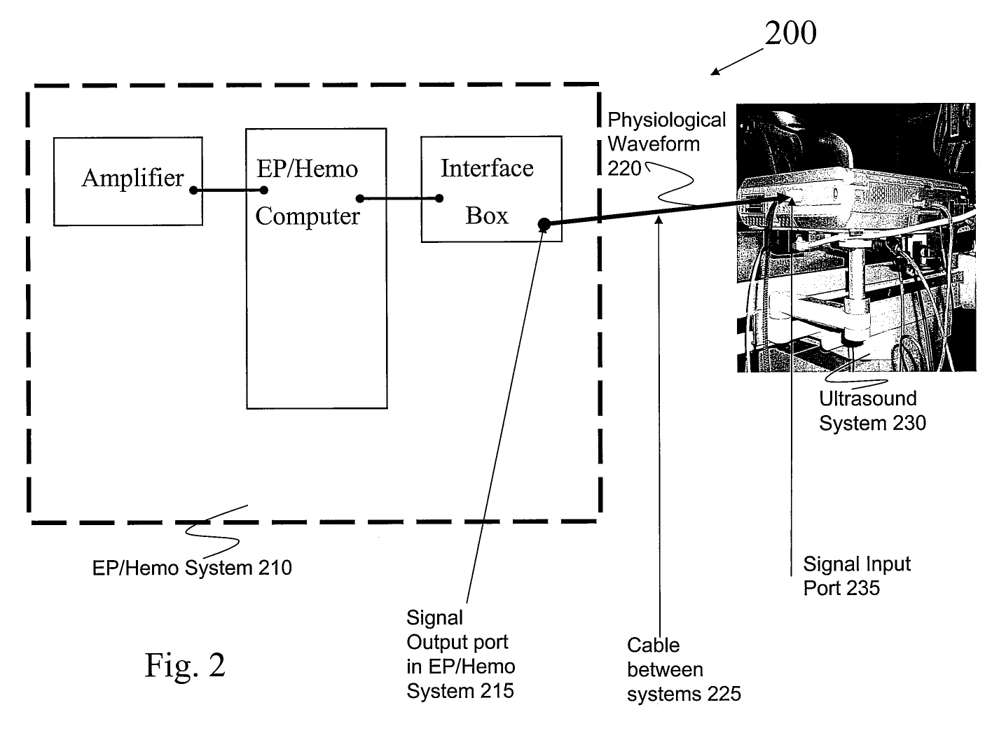

FIG. 2 illustrates a more detailed diagram of an integrated EP/Hemo and ultrasound system 200 in accordance with an embodiment of the present invention. The system 200 includes an EP/Hemo system 210, physiological waveform data 220 and/or other data on a cable 225, and an ultrasound system 230. The ultrasound system 230 includes a signal input port 235. The EP/Hemo system 210 also includes a signal output port 215, among other components.

As described above, data, such as physiological waveform data 220, is acquired from a patient or external system at the EP/Hemo system 210. The data 220 is transmitted from the EP/Hemo system 210 via the signal output port 215. The waveform data 220 is transmitted to the ultrasound system 230 via the cable connection 220. Note that the cable connection 220 may encompass a variety of cable connections, as well as non-cable connections such as wireless, infrared, etc. The data 220 is received at the signal input port 235 of the ultrasound system 230. Similarly, data 220 may be communicated from the ultrasound system 230 to the EP/Hemo system 210 via the connection 225 and ports 235, 215.

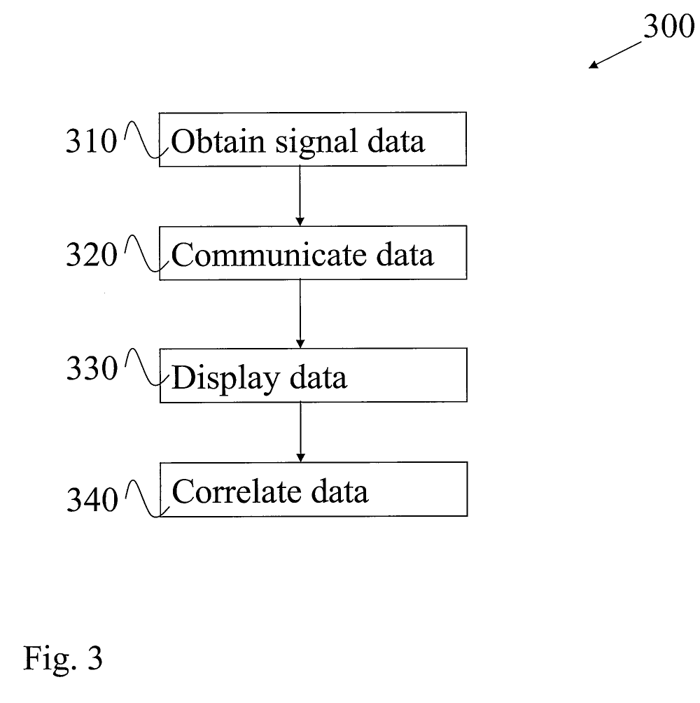

FIG. 3 illustrates a flow diagram for a method 300 for exchanging physiological signal data between an EP/Hemo recording/monitoring system and an ultrasound system in accordance with an embodiment of the present invention. At step 310, physiological signal data is obtained from a patient. For example, ECG and/or intracardiac waveform data is acquired from a patient by the EP/Hemo system using a sensor and/or other monitor. At step 320, the physiological signal data is communicated from the EP/Hemo system to the ultrasound system via a data connection in an integrated EP/Hemo and ultrasound system environment. At step 330, the physiologic signal data is displayed simultaneously (or at least substantially simultaneously given some inherent transmission and/or processing delay) at the EP/Hemo system and the ultrasound system. At step 340, signal information is correlated with image information for display and/or processing. Thus, ECG/intracardiac waveform information may be correlated with ultrasound image data for display, further processing, reporting and/or analysis by a clinician, for example.

One or more of the steps of the method 300 may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

Certain embodiments provide biometric authentication in a physiological monitoring system, such as an integrated EP/Hemo system. Integrating a biometric scan into physiological monitoring systems allows a user to enter the system and access controlled sections without manual entry of a password, pass code or other identifier. An example of a biometric scanner may be a finger print reader built into a system keyboard that would allow the user to use a finger touch on a sensor when prompted for password access into the system. Other examples may include eye (retina) scanners and hand print scanners. System access may be improved through biometric scanning as additional typing and memorization of alphanumeric codes by a user are reduced. A biometric scan provides a unique identifier for a user and reduces management and updating of passwords and/or access codes, for example. That is, a biometric scan helps eliminate periodic management and updating of passwords for system access. In certain embodiments, a radio frequency identifier (RFID) and/or other identification device may be used for identification, for example.

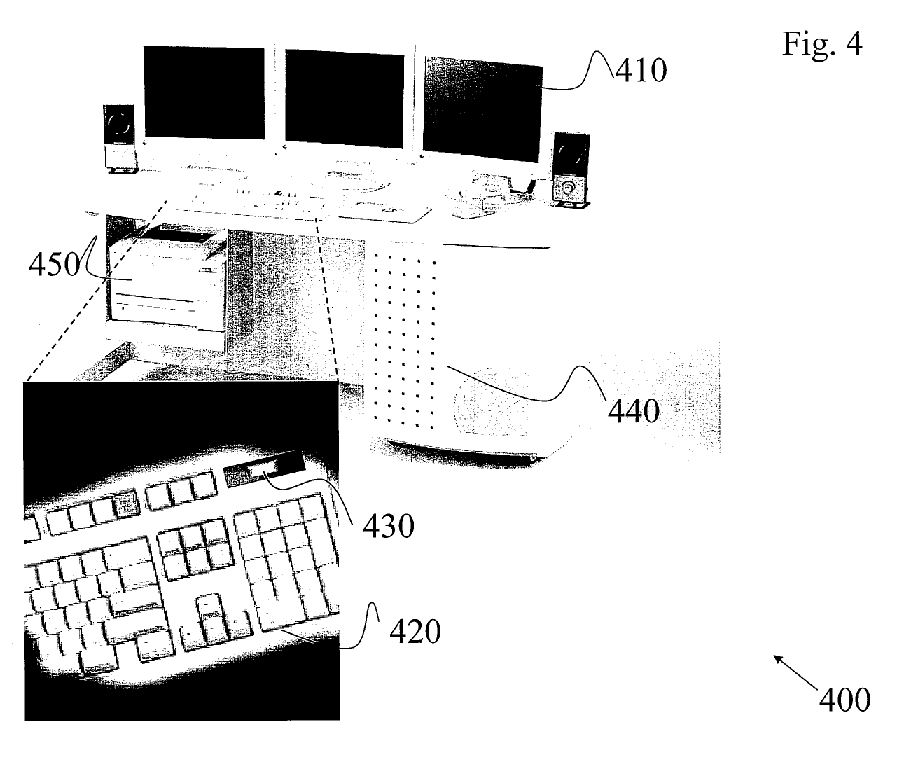

FIG. 4 illustrates an integrated EP/Hemo system 400 with biometric scanning capability in accordance with an embodiment of the present invention. The system 400 includes one or more displays 410, one or more input devices such as a keyboard 420, a biometric scanner 430, a computing device 440 and an input/output device, such as a printer 450. In certain embodiments, a user may use the biometric scanner 430 to input authentication information rather than (or in addition to) entering information via the keyboard 420 or other input device (e.g., mouse, touch screen, etc.). The computer device 440 may prompt a user to provide biometric information, such as fingerprint information, via the biometric scanner 430. For example, the biometric scanner 430 may be integrated into the system 400, such as integrated into the keyboard 440. Alternatively and/or in addition, the biometric scanner 430 may be integrated into another component of the system 400, such as the display 410, the printer 450, and/or other system component, such as an imaging scanner or patient monitoring device (not pictured).

The biometric scanner 430 may be a fingerprint scanner, an eye (e.g., retina) scanner, a hand print scanner, and/or a voice recognition scanner, for example. As shown in FIG. 4, the fingerprint biometric scanner 430 is built into the keyboard 440 of the physiological monitoring system, such as a GE CardioLab/Mac-Lab system keyboard. The biometric scanner 430 includes a sensor or reader to obtain the biometric data. For example, a user may simply place his or her finger on the sensor to provide biometric data to the scanner 430. The scanner 430 transmits the data to the computing device 440 and/or external authentication system to match the data against stored biometric data. If the data matches, the user may be granted access to the system and/or functionality. In certain embodiments, the authentication also involves a check of privilege associated with the identified user. For example, a user is verified and then the user's right to access a certain functionality and/or system is also verified before the user is granted access. Thus, the system may provide several levels of security through biometric scanning instead of and/or in addition to other password or passcode protection. In certain embodiments, various levels and/or types of authentication may be verified for user access to functionality.

The components of the system 400 may be implemented in software, hardware and/or firmware, for example. The components of the system 400 may be implemented separately and/or integrated in a plurality of forms.

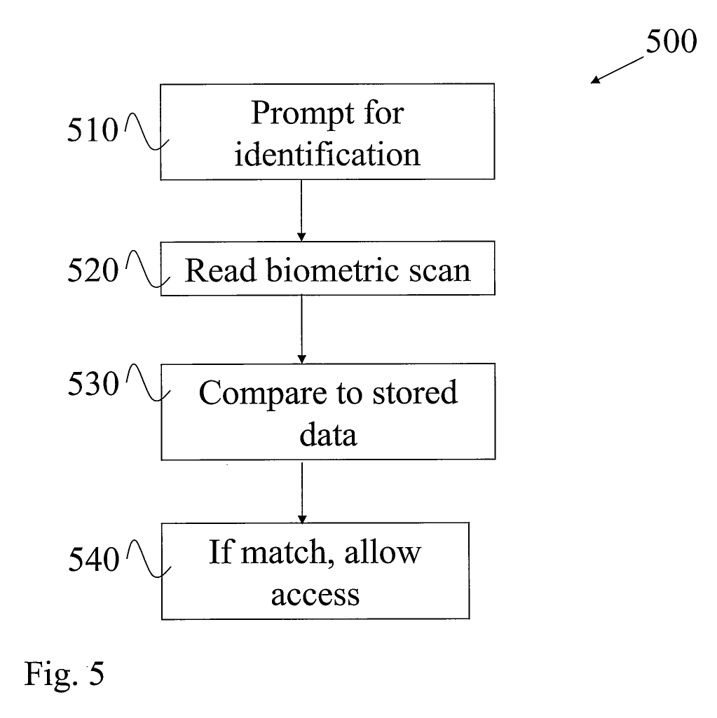

FIG. 5 illustrates a flow diagram for a method 500 for biometric identification in an integrated EP/Hemo system in accordance with an embodiment of the present invention. At step 510, a user is prompted for identification. For example, a user is prompted by a message on a display to provide a fingerprint sample. At step 520, biometric data is read from the user. For example, a user places his or her index finger on a biometric sensor, and the fingerprint data is recorded by the sensor.

At step 530, the biometric data is compared to stored biometric identification data for the user. For example, the user's fingerprint is compared against a stored fingerprint record for that user. Additionally, a level of privilege or access to system(s) and/or functionality may also be verified. At step 540, if a user is verified, then the user is allowed access. For example, if a user's fingerprint matches the record, then the user is allowed to log in to the system.

One or more of the steps of the method 500 may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

Thus, certain embodiments provide biometric scanning integrated into a computerized clinical system that is being utilized to care for patients during complex invasive cardiac and radiological procedures. Certain embodiments help to provide improved security from copying and tampering, as well as improved user workflow and procedure time. Certain embodiments provide biometric scanning with several levels of security. Certain embodiments provide an integrated combination of a biometric scan with a physiological monitoring and recording system for hemodynamic and electrophysiology procedures.

Certain embodiments help improve ease of use of physiological diagnostic monitoring systems through biometric scanning. Certain embodiments help eliminate a need for a user to remember and manage multiple alphanumeric passwords. Certain embodiments help increase efficiency and decrease case time by eliminating a need to type multiple keystrokes instead of a ‘swipe’ of a finger on a finger print reader or other biometric scanner. Certain embodiments also provide a unique identifier for tracking and auditing access to the system. For example, biometric authentication helps eliminate password theft.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A clinical diagnostic system accessible via biometric identification, said system comprising:
a biometric scanner integrated with said clinical diagnostic system, said biometric scanner receiving biometric data from a user; and
a processing device in communication with said biometric scanner, said processing device receiving said biometric data from said biometric scanner and verifying said biometric data against a stored biometric identification, said processing device allowing user access to said clinical diagnostic system based on said verification.

2. The system of claim 1, wherein said clinical diagnostic system comprises a physiological monitoring and recording system for hemodynamic and electrophysiology procedures and said biometric scanner is integrated with said physiological monitoring and recording system.

3. The system of claim 1, wherein said biometric scanner is integrated with a keyboard included in said clinical diagnostic system.

4. The system of claim 1, wherein said biometric scanner is integrated with at least one of a display, a printer, an imaging scanner and a patient monitoring device.

5. The system of claim 1, wherein said biometric data comprises at least one of user fingerprint data, user retina data and user voiceprint data.

6. The system of claim 1, wherein said stored biometric identification is stored on an external server.

7. The system of claim 1, wherein said processing device facilitates tracking and auditing access to the system using said biometric data.

8. The system of claim 1, wherein said processing device accepts said biometric data in place of a password.

9. The system of claim 1, wherein said processing device verifies a level of access to said system.

10. A method for biometric authentication of a user at a physiological monitoring and recording system for hemodynamic and electrophysiology procedures, said method comprising:
prompting a user for biometric identification;
obtaining biometric data from the user via a biometric scanner integrated with said physiological monitoring and recording system for hemodynamic and electrophysiology procedures;
comparing said obtained biometric data to stored biometric data; and
allowing access to a function at said physiological monitoring and recording system for hemodynamic and electrophysiology procedures when said obtained biometric data is identified as matching said stored biometric data.

11. The method of claim 10, wherein said biometric data comprises at least one of user fingerprint data, user retina data and user voiceprint data.

12. The method of claim 10, further comprising tracking and auditing access to the system using said obtained biometric data.

13. The method of claim 10, wherein said step of prompting further comprises allowing the user to provide biometric identification when prompted for password access into the system.

14. The method of claim 10, further comprising verifying a level of access to the system.

15. The method of claim 10, wherein said biometric scanner is integrated with a keyboard associated with the system.

16. A computer-readable medium including a set of instructions for execution on a computer, said set of instructions comprising:
a biometric scanning routine receiving biometric identification data for a user, said biometric scanning routine integrated with a clinical diagnostic system; and
a verification routine verifying access to functionality of said clinical diagnostic system based on a comparison of said biometric identification data to stored biometric identification data.

17. The computer-readable medium of claim 16, wherein said clinical diagnostic system comprises a system for hemodynamic and electrophysiology procedures.

18. The computer-readable medium of claim 16, wherein said verification routine verifies a level of access to the system for the user.

19. The computer-readable medium of claim 16, wherein said set of instructions further includes a tracking routine for tracking and auditing access to the system using said biometric identification data.

20. The computer-readable medium of claim 16, wherein said verification routine compares said biometric identification data to biometric identification data stored on an external system.
